(19) United States
(12) Patent Application Publication
(10) Pub. No.: US 2014/0122799 A1
(43) Pub. Date: May 1, 2014

(54) STORAGE DEVICE AND POWER SAVING METHOD THEREOF

(71) Applicants: INVENTEC (PUDONG) TECHNOLOGY CORPORATION, Shanghai (CN); INVENTEC CORPORATION, Taipei (TW)

(72) Inventors: Kuo-Shu Chiu, Taipei (TW); Chien-Chou Chen, Taipei (TW); Jo-Yu Chang, Taipei (TW); Szu-Hsien Lee, Taipei (TW)

(73) Assignees: INVENTEC CORPORATION, Taipei (TW); INVENTEC (PUDONG) TECHNOLOGY CORPORATION, Shanghai (CN)

(21) Appl. No.: 13/793,429

(22) Filed: Mar. 11, 2013

(30) Foreign Application Priority Data
Oct. 26, 2012 (CN) 201210417660.0

(51) Int. Cl. G06F 1/26

(52) U.S. Cl. CPC G06F 1/266
USPC 711/114; 713/310

(57) ABSTRACT

A storage device includes a plurality of hard disk device sets, a plurality of voltage adjustment units, an information collection unit and a control unit. The hard disk device sets access data respectively to generate corresponding access messages. Each of the hard disk device sets includes at least two hard disk devices. The voltage adjustment units determine whether to provide a plurality of duty voltages to the hard disk device sets, according to a plurality of control signals. The information collection unit receives the access messages generated by the hard disk device sets, and outputs the access messages according to a read command. The control unit generates the read command to receive the access messages, acquires the usage states of the hard disk device sets according to an algorithm and the access messages, and generates the control signals according to the usage states of the hard disk device sets.

### CROSS-REFERENCE TO RELATED APPLICATIONS

This non-provisional application claims priority under 35 U.S.C. §119(a) on Patent Application No(s). 201210417660.0 filed in China on Oct. 26, 2012, the entire contents of which are hereby incorporated by reference.

### BACKGROUND OF THE INVENTION

1. Technical Field of the Invention

The disclosure relates to a power saving method, and more particularly to a storage device and a power saving method thereof

2. Description of the Related Art

In the operation of a server, excepting the cooling system, the component, which consumes the most power, is the central processing unit (CPU), the second is the memory, and the third is the hard disk.

Along with the improvement and development of cloud concepts and techniques, each single motherboard in the server may correspond to more and more hard disks, for example, one motherboard corresponds to eight hard disks and even to forty hard disks. Thus, the server provides better and flawless services.

In a server, not all of the hard disks are accessing data all the time. Moreover, when the server starts to work, the power supply in the server also provide power to all of the hard disks. Herein, these hard disks enter the work state, that is, access data immediately whenever receiving an access command. Thus, the power consumption of the server is increased.

### SUMMARY OF THE INVENTION

According to the aforementioned problems, the disclosure provides a storage device and a power saving method thereof, in order to effectively reduce extra power consumption and save power.

A storage device in the disclosure includes a plurality of hard disk device sets, a plurality of voltage adjustment units, an information collection unit and a control unit. Each of the plurality of hard disk device sets accesses data to generate an access message. Each of the plurality of hard disk device sets includes at least two hard disk devices. The voltage adjustment units are coupled to the plurality of hard disk device sets, provide a plurality of duty voltages to the plurality of hard disk device sets, and according to a plurality of control signals, determine whether to provide the duty voltages or not. The information collection unit is coupled to the plurality of hard disk device sets, receives the access messages generated by the plurality of hard disk device sets, and according to a read command, outputs the access messages. The control unit is coupled to the information collection unit and the voltage adjustment units, generates the read command to receive the access messages, and according to an algorithm and the access messages, acquires the usage states of the plurality of hard disk device sets. The control unit correspondingly generates the plurality of control signals according to the usage states of the plurality of hard disk device sets.

In an embodiment, the control unit is coupled to the information collection unit and the voltage adjustment units through an inter integrated circuit bus or a serial peripheral interface bus.

In an embodiment, the hard disk device set is a redundant array of independent disks.

In an embodiment, the control unit is a baseboard management controller.

In an embodiment, the information collection unit and the voltage adjustment units are integrated in a hard disk device expansion card.

The disclosure discloses a power saving method of a storage device, which includes the following steps. A plurality of access messages generated by a plurality of hard disk device sets are collected through the information collection unit. Each of the plurality of hard disk device sets includes at least two hard disk devices. A read command is generated through the control unit. The access messages are outputted by the information collection unit according to the read command to the control unit. The usage states of the plurality of hard disk device sets are acquired by the control unit according to the algorithm and the access messages. A plurality of control signals are outputted according to the usage states of the plurality of hard disk device sets to the voltage adjustment units, so as to control whether the voltage adjustment units provide the duty voltages to the plurality of hard disk device sets or not.

In an embodiment, the control unit is coupled to the information collection unit and the voltage adjustment units through an inter integrated circuit bus or a serial peripheral interface bus.

In an embodiment, the hard disk device set is a redundant array of independent disks.

In an embodiment, the control unit is a baseboard management controller.

The storage device and the power saving method thereof in the disclosure, use the information collection unit to receive the access messages generated by all of the plurality of hard disk device sets. The control unit receives the access messages from the information collection unit, and acquires the usage states of all the plurality of hard disk device sets according to an algorithm and the access messages to output the plurality of control signals to the voltage adjustment units, so as to control some voltage adjustment units to stop providing power. Herein, the plurality of hard disk device sets, which are idle for a long time or are used less frequently, stop working. Therefore, the extra power consumption may be effectively reduced, for saving power.

### BRIEF DESCRIPTION OF THE DRAWINGS

The present disclosure will become more fully understood from the detailed description given herein below for illustration only, and thus does not limit the present disclosure, wherein:

FIG. 1 is a schematic diagram of a storage device according to the disclosure;

FIGS. 2A to 2D are respectively a schematic diagram of the arrangement of a hard disk device set according to the disclosure; and

FIG. 3 is a flow chart of a power saving method of a storage device according to the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

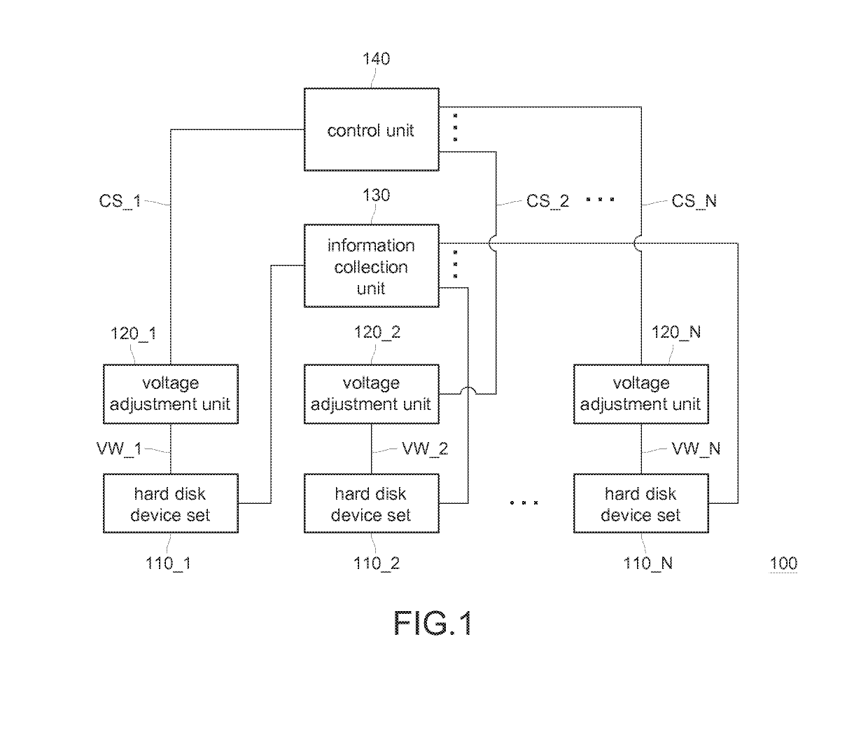

FIG. 1 is a schematic diagram of a storage device according to the disclosure. The storage device 100 in this embodiment is adapted to a server. The storage device 100 includes the hard disk device sets 110_1 to 110_N, the voltage adjustment units 120_1 to 120_N, the information collection unit 130 and the control unit 140.

Each of the hard disk device sets 110_1 to 110_N accesses data to generate an access message. For example, the data is stored in the storage device 100, such as in the hard disk device set 110_1. The hard disk device set 110_1 accesses data to generate an access message which indicates that the hard disk device set 110_1 has accessed data. The rest of the hard disk device sets also operate as the hard disk device set 110_1. The hard disk device sets 110_1 to 110_N are, for example, redundant arrays of independent disks (RAID), and each hard disk device set includes at least two hard disk devices.

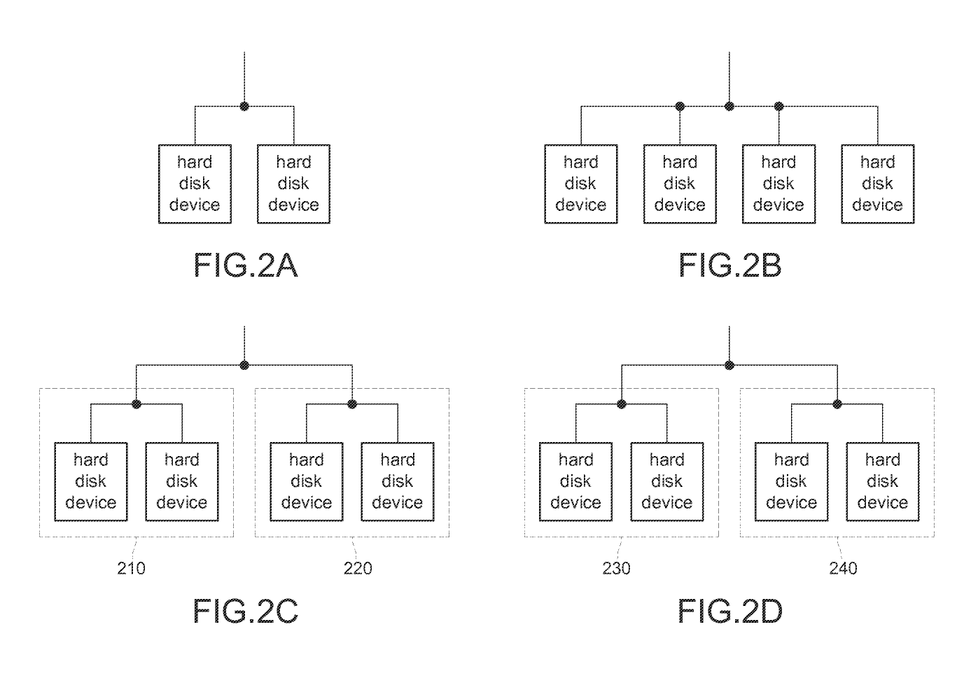

For example, the hard disk device sets 110_1 to 110_N are RAID 0 or RAID 1. Herein, each of the hard disk device sets 110_1 to 110_N includes two hard disk devices, and the two hard disk devices are connected to each other in parallel as shown in FIG. 2A. For example, the hard disk device sets 110_1 to 110_N are RAID 3, RAID 4 or RAID 5. Herein, each of the hard disk device sets 110_1 to 110_N includes four hard disk devices, and the four hard disk devices are connected with one another in parallel as shown in FIG. 2B.

For example, the hard disk device sets 110_1 to 110_N are RAID 0 plus RAID 1. Herein, each of the hard disk device sets 110_1 to 110_N includes two RAID 1 type hard disk device sets 210 and 220. The hard disk device sets 210 and 220 are connected to each other in parallel, and each of the hard disk device sets 210 and 220 includes two RAID 0 type hard disk devices which are connected with each other in parallel, as shown in FIG. 2C.

For example, the hard disk device sets 110_1 to 110_N are RAID 1 plus RAID 0. Herein, each of the hard disk device sets 110_1 to 110_N includes two RAID 0 type hard disk device sets 230 and 240. The hard disk device sets 230 and 240 are connected in parallel, and each of the hard disk device sets 230 and 240 includes two RAID 1 type hard disk devices which are connected with each other in parallel, as shown in FIG. 2D.

The voltage adjustment units 120_1 to 120_N are coupled to the hard disk device sets 110_1 to 110_N to provide duty voltages VW_1 to VW_N to the hard disk device sets 110_1 to 110_N, so that the hard disk device sets 110_1 to 110_N work normally and access data. In addition, the voltage adjustment units 120_1 to 120_N determine whether to provide the duty voltage VW_1 to VW_N, according to the control signals CS_1 to CS_N.

For example, when the control signals CS_1 to CS_N are high logical levels, the voltage adjustment units 120_1 to 120_N provide the duty voltages VW_1 to VW_N to make the hard disk device sets 110_1 to 110_N work normally. Otherwise, when the control signals CS_1 to CS_N are low logical levels, the voltage adjustment units 120_1 to 120_N do not provide the duty voltages VW_1 to VW_N, so that the hard disk device sets 110_1 to 110_N do not work. Thus, the disclosure may save power.

The information collection unit 130 is coupled to the hard disk device sets 110_1 to 110_N, and receives the access messages generated by the hard disk device sets. That is, the access messages generated by the hard disk device sets 110_1 to 110_N are transmitted to the information collection unit 130, and the information collection unit 130 stores the access messages in a memory thereof, and further records the number of times of generating the access messages indicate the usage states of the hard disk device sets 110_1 to 110_N.

In addition, the information collection unit 130 outputs the access messages according to the read command. That is, when receiving the read command, the information collection unit 130 outputs the collected access messages. When not receiving the read command yet, the information collection unit 130 does not output the collected access messages and continuously collects the access messages generated by the hard disk device sets 110_1 to 110_N.

The control unit 140 is coupled to the information collection unit 130 and the voltage adjustment units 120_1 to 120_N, generates the read command, and receives the access messages. For example, the control unit 140 outputs the read command regularly to the information collection unit 130, so that the information collection unit 130 transmits the access messages stored in the memory of the information collection unit 130 to the control unit 140 to execute following processes.

Subsequently, the control unit 140 acquires the usage states of the hard disk device sets 110_1 to 110_N according to an algorithm and the access messages. That is, the control unit 140 calculates all of the received access messages according to the algorithm installed in the control unit 140. For example, the control unit 140 calculates the number of times which each of the hard disk device sets 110_1 to 110_N generate access messages to match the usage states of each of the hard disk device sets 110_1 to 110_N.

For example, the more the number of times of generating access messages in a predetermined time period, the more frequency the hard disk device sets 110_1 to 110_3 are used. In contrast, the number of times of generating access messages in the predetermined time period is less, which indicates that the hard disk device sets 110_4 to 110_N are “idle” or “used less. The predetermined time period is designed by the users according to their actual needs, so that the control unit 140 can effectively determine the usage states of the hard disk device sets 110_1 to 110_N.

Then, the control unit 140 generates corresponding control signals CS_1 to CS_N according to the usage states of the hard disk device sets 110_1 to 110_N. For example, when the control unit 140 determines that the hard disk device sets 110_1 to 110_3 are frequently used, the control unit 140 generates high logic levels of the control signals CS_1 to CS_3 to control the voltage adjustment units 120_1 to 120_3 to provide the duty voltages VW_1 to VW_3 to the hard disk device sets 110_1 to 110_3, so that the hard disk device sets 110_1 to 110_3 remain working.

In contrast, when the control unit 140 determines that the hard disk device sets 110_4 to 110_N are idle or not frequently used, the control unit 140 generates low logic levels of the control signals CS_4 to CS_N to control the voltage adjustment units 120_4 to 120_N to not provide the duty voltages VW_4 to VW_N to the hard disk device sets 110_4 to 110_N, so that the hard disk device sets 110_4 to 110_N stop working Therefore, the power consumption of the storage device 100 may be effectively reduced so as to save power.

In this embodiment, the algorithm is, for example, the least recently used (LRU) algorithm. In addition, the control unit 140 is, for example, a baseboard management controller (BMC). The control unit 140 is coupled to the information collection unit 130 and the voltage adjustment units 120_1 to 120_N through, for example, an inter integrated circuit (IIC) bus or a serial peripheral interface (SPI) bus. Moreover, the information collection unit 130 and the voltage adjustment units 120_1 to 120_N can be integrated in a hard disk device (HDD) expansion card.

In the above embodiments, the control unit 140, the hard disk device sets 110_1 to 110_N, the voltage adjustment units 120_1 to 120_N and the information collection unit 130 are disposed in the same server. In another embodiment, the control unit 140 can be disposed in another server, and the relating controls and operations (such as the providing of duty voltages) of the storage device 100 are controlled by another server. The relating controls and operations can be referenced to the aforementioned embodiments, and are not repeatedly described.

On the basis of the above embodiments, a power saving method of a storage device may be derived as follows.

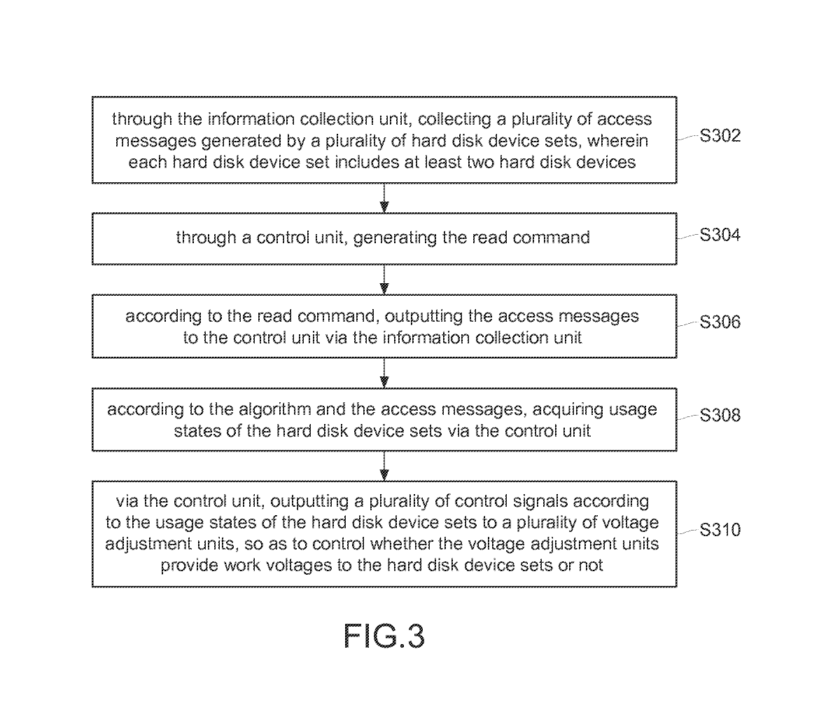

FIG. 3 is a flow chart of a power saving method of a storage device according to the disclosure. In step S302, a plurality of access messages generated by a plurality of hard disk device sets are collected through an information collection unit. Each of the hard disk device sets includes at least two hard disk devices. In step S304, a read command is generated through a control unit.

In step S306, the information collection unit outputs the access messages to the control unit according to the read command. In step S308, the control unit acquires the usage states of the hard disk device sets according to an algorithm and the access messages. In step S310, a plurality of control signals are correspondingly outputted according to the usage states of the hard disk device sets to a plurality of voltage adjustment units so as to control whether the voltage adjustment units output the duty voltages to the hard disk device sets or not.

In this embodiment, the read command, access messages, and control signals are transmitted through one of the inter integrated circuit bus and the serial peripheral interface bus. The hard disk device set is, for example, a redundant array of independent disks. The control unit is, for example, a baseboard management controller.

In the disclosure, the information collection unit receives the access messages generated by all hard disk device sets, the control unit receives the access messages from the information collection unit, and acquires the usage states of all the hard disk device sets according to an algorithm and the access messages to output corresponding control signals to the voltage adjustment units to control some voltage adjustment units to stop providing electric power. In this way, the hard disk device sets, which are idle for a long time or not frequently used, stop working, so that the extra power consumptions may be effectively reduced to save power.

What is claimed is:

1. A storage device, comprising:
a plurality of hard disk device sets, for respectively accessing data to generate an access message, wherein each of the plurality of hard disk device sets comprises at least two hard disk devices;
a plurality of voltage adjustment units, coupled to the plurality of hard disk device sets, for providing a plurality of duty voltages to the plurality of hard disk device sets, and for determining whether to provide the plurality of duty voltages or not, according to a plurality of control signals;
an information collection unit, coupled to the plurality of hard disk device sets, for receiving the access message of the plurality of hard disk device sets generated by the plurality of hard disk device sets, and for outputting the access messages of the plurality of hard disk device sets according to a read command; and
a control unit, coupled to the information collection unit and the voltage adjustment units, for generating the read command so as to receive the access message of the plurality of hard disk device sets, for obtaining usage states of the plurality of hard disk device sets according to an algorithm and the access message of the plurality of hard disk device sets, and for correspondingly generating the plurality of control signals according to the usage states of the plurality of hard disk device sets.

2. The storage device according to claim 1, wherein the control unit is coupled to the information collection unit and the plurality of voltage adjustment units through one of an inter integrated circuit bus and a serial peripheral interface bus.

3. The storage device according to claim 1, wherein each of the plurality of hard disk device sets is a redundant array of independent disks.

4. The storage device according to claim 1, wherein the control unit is a baseboard management controller.

5. The storage device according to claim 1, wherein the information collection unit and the plurality of voltage adjustment units are integrated in a hard disk device expansion card.

6. A power saving method of a storage device, comprising:
via an information collection unit, collecting a plurality of access messages generated by a plurality of hard disk device sets, wherein each of the plurality of hard disk device sets comprises at least two hard disk devices;
via a control unit, generating a read command;
according to the read command, outputting the plurality of access messages from the information collection unit to the control unit;
according to an algorithm and the plurality of access messages, obtaining usage states of the plurality of hard disk device sets via the control unit; and
outputting a plurality of control signals from the control unit to a plurality of voltage adjustment units according to the usage states of the plurality of hard disk device sets, so as to control whether the voltage adjustment units provide duty voltages to the plurality of hard disk device sets or not.

7. The power saving method of the storage device according to claim 6, wherein the read command, the plurality of access messages and the plurality of control signals are transmitted through one of an inter integrated circuit bus and a serial peripheral interface bus.

8. The power saving method of the storage device according to claim 6, wherein each of the plurality of hard disk device set is a redundant array of independent disks.

9. The power saving method of the storage device according to claim 6, wherein the control unit is a baseboard management controller.
